(19) United States
(12) Patent Application Publication
(10) Pub. No.: US 2018/0137557 A1
(43) Pub. Date: May 17, 2018

(54) Sharing Digital Shopping Carts in Online Shopping Systems

(71) Applicant: Chegg, Inc., Santa Clara, CA (US)

(72) Inventors: Bhargav Vadher, Santa Clara, CA (US); Lana Laver, Santa Clara, CA (US); Vincent Le Chevalier, Santa Clara, CA (US); Pauli Wang, Cupertino, CA (US)

(21) Appl. No.: 15/354,958

(22) Filed: Nov. 17, 2016

(51) Int. Cl. G06Q 30/06; G06Q 20/10; G06F 17/30

(52) U.S. Cl. CPC G06Q 30/0633; G06Q 50/01; G06F 17/30864; G06Q 20/102

(57) ABSTRACT

An online shopping system receives a digital shopping cart representing a set of identifiers of one or more items offered for sale by the shopping system and selected for purchase by a first user. A uniform resource locator (URL) is generated that uniquely references the digital shopping cart. The online shopping system receives a request from a second user to access the URL. Responsive to receiving the request, a digital shopping cart is configured for the second user including the set of identifiers of the one or more items.

### BACKGROUND

This disclosure relates generally to online shopping, and in particular to sharing online shopping carts.

Online shopping systems provide a convenient mechanism for users to access and purchase a wide variety of items. When shopping online, users typically search online shopping systems for items, often by submitting search queries to the systems and browsing search results returned in response to the queries. Users can then add items they desire to purchase to digital shopping carts, which store identifiers of the items until the users are ready to purchase the items.

In some online shopping systems, many users will purchase the same or similar sets of items. Thus, users will search a shopping system for the same or similar set of items as were purchased by many other users. For example, many students enrolled in the same educational course will be required to purchase the same set of textbooks, because those textbooks are required for the course. Accordingly, many users of a shopping system selling textbooks and other educational materials will purchase the same set of books from the shopping system. Students enrolled in the same course will search the system for the books required for the course, add the books to a shopping cart, and check out the cart to purchase the books. Replicating searching in this manner is taxing on users, and requires the online shopping system to execute the same search queries numerous times.

### SUMMARY

An online shopping system enables users to share digital shopping carts to reduce a number of individual search queries submitted to the system and improve user experience on the system. Users search the online shopping system for items to purchase and add desired items to a digital shopping cart. The online shopping system receives a digital shopping cart, representing a set of identifiers of one or more items offered for sale by the shopping system and selected for purchase by a first user of the shopping system. For example, the first user searches the online system for items the first user desires to purchase, and any items the first user selects are added to a digital shopping cart. The online shopping system generates a uniform resource locator (URL) uniquely referencing the digital shopping cart associated with the first user. The first user or the shopping system may then share the URL with other users. For example, the first user may share the URL with a second user for the second user to purchase the items for the first user, or the first user may publically post the URL to a website or social networking system where other users may access the URL to purchase the items. When a second user accesses the URL, the online shopping system configures a digital shopping cart within the shopping system for the second user including the set of identifiers of the one or more items in the first user's shopping cart.

The features and advantages described in this summary and the following detailed description are not all-inclusive. Many additional features and advantages will be apparent to one of ordinary skill in the art in view of the drawings, specification, and claims.

### BRIEF DESCRIPTION OF THE DRAWINGS

FIG. 1 is a high-level block diagram illustrating an online shopping environment, according to one embodiment.

FIG. 2 illustrates an example digital shopping cart.

FIG. 3 is a block diagram showing modules within the shopping system, according to one embodiment.

FIG. 4 is an interaction diagram illustrating a process for generating a shareable shopping cart URL, according to one embodiment.

FIG. 5 is an interaction diagram illustrating a process for sharing a shopping cart URL, according to one embodiment.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### System Overview

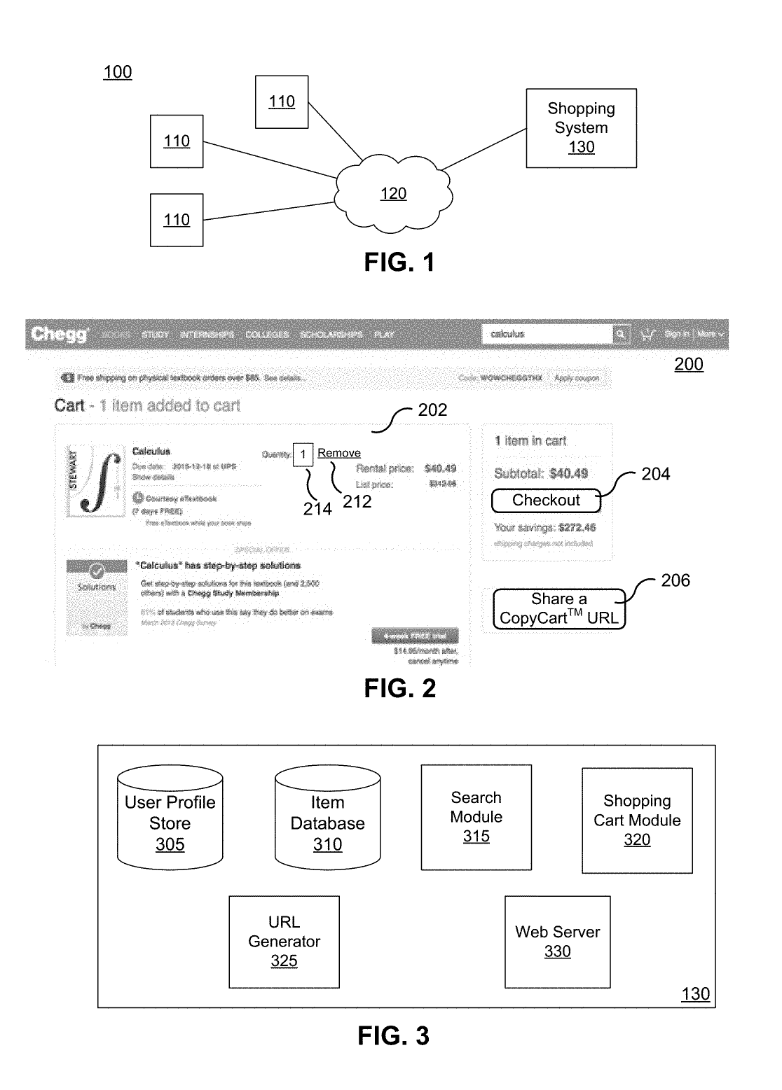

FIG. 1 is a high-level block diagram illustrating an online shopping environment 100. In one embodiment, the environment includes an online shopping system 130 and one or more client devices 110 communicating with the shopping system 130 via a network 120.

The shopping system 130 comprises an e-commerce system that offers items for purchase by users of the system and enables the users to purchase the items. The shopping system 130 maintains a website including an online storefront through which users can search for and purchase desired items. When a user finds an item he desires to purchase, the user selects the item for purchase by adding the item to a digital shopping cart. The shopping system 130 stores identifiers of the items the user has selected for purchase in the digital shopping cart until the user is ready to complete the transaction, at which time the shopping system 130 provides a payment portal for the user to purchase the selected items. In one example, the shopping system 130 is part of an educational platform offering digital or printed educational content for sale to users, such as textbooks, study guides, or course supplements, or offering educational services that can be purchased by users and accessed through the educational platform.

An example shopping cart 200 generated by the shopping system 130 is shown in FIG. 2. The shopping cart 200 is displayed to a user through a website operated by the shopping system 130, and has one item 202 in it, a calculus textbook, selected for purchase by the user. The shopping cart 200 displayed to the user displays identifiers of the items in the cart, such as an image and name associated with each item. While viewing the cart 200, the user may modify the set of items in the cart by, for example, removing the item 202 from the cart by selecting a “remove” link 212, or changing the quantity of item 202 by typing a new value into a quantity box 214. If the user desires to purchase the textbook, the user may select the “checkout” button 204, which, for example, causes the shopping system 130 to display a payment portal for the user to enter payment information and a shipping address. Alternatively, the user may select the “share” button 206 to retrieve a shareable URL for the shopping cart 200.

The shopping system 130 enables users to share shopping carts by generating unique uniform resource locators (URLs) referencing a set of items in a shopping cart. A first user can share a shopping cart URL with one or more other individuals, who can then use the URL to access the set of items in the shopping cart. When a second user accesses a shopping cart URL, the shopping system 130 configures a shopping cart for the second user including the same items as the cart corresponding to the URL. The second user can then modify the cart by adding items to or removing items from the configured shopping cart, or can purchase the items in the configured shopping cart without modification. The shopping system 130 is described in further detail with respect to FIG. 3.

Users access the online shopping system 130 using client devices 110. The client devices 110 are one or more computing devices capable of receiving user input as well as transmitting and/or receiving data via the network 120. In one embodiment, a client device 110 is a conventional computer system, such as a desktop or laptop computer. Alternatively, a client device 110 may be a device having computer functionality, such as a personal digital assistant (PDA), a mobile telephone, a smartphone or another suitable device. A client device 110 is configured to communicate via the network 120. In one embodiment, a client device 110 executes an application allowing a user of the client device 110 to interact with the shopping system 130. For example, a client device 110 executes a browser application to enable interaction between the client device 110 and the shopping system 130 via the network 120. In another embodiment, a client device 110 interacts with the shopping system 130 through an application programming interface (API) running on a native operating system of the client device 110, such as IOS® or ANDROID™.

The client devices 110 and shopping system 130 are configured to communicate via the network 120, which may comprise any combination of local area and/or wide area networks, using both wired and/or wireless communication systems. In one embodiment, the network 120 uses standard communications technologies and/or protocols. For example, the network 120 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML) or extensible markup language (XML). In some embodiments, all or some of the communication links of the network 120 may be encrypted using any suitable technique or techniques.

FIG. 3 is a block diagram showing modules within the shopping system 130, according to one embodiment. In one embodiment, the shopping system 130 includes a user profile store 305, an item database 310, a search module 315, a shopping cart store 320, a URL generator 325, and a web server 330. Other embodiments of the shopping system 130 may include fewer or additional modules, and the functions may be performed by different modules.

Users of the shopping system 130 may each be associated with a user profile, which is stored in the user profile store 305. Each user profile may store information enabling a user to purchase items from the shopping system 130, such as payment information and a shipping address to which goods the user purchases can be shipped. Identifiers of items a corresponding user has previously purchased or viewed on the shopping system 130 may be stored in the user's profile. User profiles may also include declarative information about the user relating to items the user is likely to purchase. For example, a user may provide information about his occupation or hobbies to improve item recommendations from the shopping system 130. User profiles may also store information about social networking connections of the corresponding users, including identifiers of users of external social networking systems connected to the corresponding user via the social network, which are directly provided by the user or retrieved from the social networking system. In an example embodiment in which the shopping system 130 is related to an educational platform, the declarative information in a user profile may include such information as a school attended by the user, courses the user has taken or will expect to take, and a degree program in which the user is enrolled.

In some embodiments, the shopping system 130 controls access to features of the system depending on whether users have existing user profiles in the user profile store 305. For example, the shopping system 130 enables any users to browse the items offered by the system, but requires users to log in with credentials associated with a user profile before purchasing the items. As another example, the shopping system 130 allows users with existing user profiles to create shopping carts and share URLs, and allows any users to purchase items in carts created by the registered users.

The item database 310 stores identifiers of items offered by the shopping system 130 for purchase by users. The item identifiers may include any information that can be used by the shopping system 130 or a user to identify a particular item, including alphanumeric strings uniquely identifying an item (e.g., an ISBN number corresponding to a biology textbook), a name of the item (e.g., the name “Biology 101”), or an image of the item (e.g., an image showing the cover of a biology textbook). The item database 310 may store identifiers of any goods or services, including physical goods that may be shipped to purchasing users, electronic products that users can download to a client device 110 or access through the shopping system 130 or other online system, or services users can purchase through the shopping system 130. In one example, the items listed in the item database 310 are items related to educational courses, such as physical or electronic textbooks, study guides, online courses, and tutoring services. However, any other goods or services may be offered for sale by the shopping system 130 and stored in the item database 310, including physical items such as clothing or tools, electronic items such as music or videos, services such as tickets to sporting events or home repair services, online subscriptions such as a subscription to a music streaming service, or any other items.

The search module 315 facilitates user searching of the item database 310. When users submit search queries to the shopping system 130 (e.g., through a search bar displayed on a website associated with the shopping system 130), the search module 315 searches the item database 310 for items matching the query and generates a results page listing any matching items. The results page displays one or more identifiers of each matching item, and provides links for users to view more information about each item or to add items to a shopping cart. Users can browse the results page and select any items they wish to purchase.

In one embodiment, the search module 315 analyzes search queries submitted to the shopping system 130 to identify trends or patterns in items for which users search. For example, the search module 315 identifies items for which users frequently search within close proximity in time to other items, such as within the same shopping session before leaving the shopping system website. The search module 315 may additionally or alternatively identify items for which similar users frequently search. For example, the search module 315 identifies items searched for by users sharing one or more common characteristics, such as location, hobbies, or course enrollments.

The shopping cart module 320 generates and stores shopping carts. Each shopping cart represents a set of items selected for purchase and includes identifiers of the items in the set. Some shopping carts may include items selected by a user, and are generated by the shopping cart module 320 while the user browses the shopping system 130 for items to purchase. In these cases, the shopping cart module 320 retrieves and stores identifiers of any items the user selects for purchase as the user browses the items offered for sale by the shopping system 130. The shopping cart module 320 may also select items to recommend the user add to a shopping cart. For example, the shopping cart module 320 selects items in which the user is likely to be interested based on the other items in the shopping cart, or based on information in the user's user profile. In one embodiment, the shopping cart module 320 also automatically generates shopping carts to include sets of items for which users have frequently searched within a relatively short period of time, sets of items frequently purchased together by users, or a set of newer editions or models of items placed in a shopping cart by a user.

The shopping cart module 320 may store a shopping cart for a specified period of time, such as one week, or may store a cart indefinitely. If a cart is accessed by a user after the cart is initially created (e.g., if a user accesses his previous carts through his account on the shopping system 130, or if a user accesses a shopping cart URL), the shopping cart module 320 retrieves identifiers of the items in the cart and displays representations of the items to the user. In one embodiment, the shopping cart module 320 selects advertisements to display with the items in shopping carts selected by users. For example, the shopping cart module 320 displays one or more recommended items to a user, where the recommended items are selected based on the other items in the cart or information stored in the user's user profile.

The URL generator 325 generates unique URLs for shopping carts created by users of the shopping system 130. Each URL uniquely references the set of items in a corresponding shopping cart, including an identifier and quantity of each item in the cart. For example, the URL comprises a string of characters including or referencing identifiers of each item in the cart and associated quantities, such that the shopping system 130 can generate a cart including the same items when the URL is accessed. Alternatively, the URL references a location associated with the shopping system 130, such as an entry in the shopping cart store 320, where identifiers and quantities of each item in the shopping cart are stored. In one embodiment, the URL generator 325 shortens a URL by encoding at least a portion of the URL. For example, since a URL referencing a large number of item identifiers may be sufficiently long to be unwieldy to share, the URL generator 325 may generate a string of characters encoding at least a portion of the URL and redirecting browsers to the full URL. The URL generator 325 may alternatively send URLs to a third party URL shortening service, which shortens the URL and returns a shortened URL to the shopping system 130 for sharing by the user.

In one embodiment, the URL generator 325 assigns each URL or shortened URL a time of expiry. For example, a URL is assigned an expiration time of one week or one year after the URL is generated. Prior to the time of expiry of a URL, the URL can be used to access the corresponding shopping cart. The URL becomes invalid after the time of expiry, regulating distribution and use of each URL. In one example, a URL for a shopping cart containing textbooks expires one year after the shopping cart was created to encourage users to search for new editions of the textbooks in the cart, rather than re-using shopping carts containing older editions.

The URLs generated by the URL generator 325 may also be associated with an identifier of the user who created the corresponding shopping cart. For example, the URL generator 325 encodes a unique identifier of the user into the URL. When other users of the shopping system 130 access a URL for a shopping cart created by a first user, the URL generator 325 attributes the use of the URL to the first user. In one embodiment, the URL generator 325 stores credits in the user's user profile based on activity associated with a URL. For example, a user earns credit for each use of the user's URL, or for sharing the URL. The shopping system 130 may offer incentives to users based on the number of credits each user earns.

The web server 330 links the shopping system 130 via the network 120 to the one or more client devices 110. The web server 330 serves web pages, as well as other web-related content, such as JAVA®, FLASH®, XML and so forth. The web server 330 may receive and route messages between the shopping system 130 and the client device 110, for example, instant messages, queued messages (e.g., email), text messages, short message service (SMS) messages, or messages sent using any other suitable messaging technique. Additionally, the web server 330 may provide application programming interface (API) functionality to send data directly to native client device operating systems, such as IOS®, ANDROID™, WEBOS® or RIM®.

### Generating Shareable Shopping Cart URLs

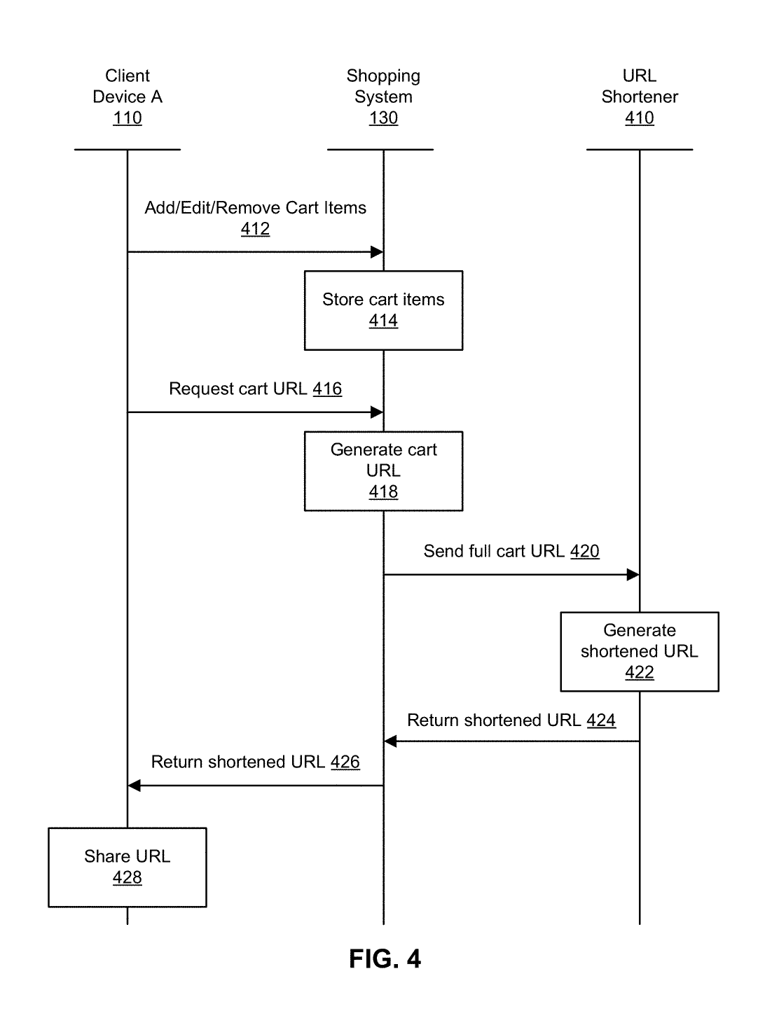

FIG. 4 is an interaction diagram illustrating one embodiment of a process for generating a shareable shopping cart URL. As shown in FIG. 4, the process may include interactions between a client device 110, the shopping system 130, and a URL shortener 310. Other embodiments may include additional, fewer, or different steps, and may perform the steps in different orders. For example, functions of the URL shortener 310 may be omitted or performed by the shopping system 130.

Using the client device 110, a user browses the items offered for sale by the shopping system 130. As the user searches the content, the user may add 412 items to a shopping cart, remove 412 items from the shopping cart, or edit 412 the items in the cart (by, for example, changing a quantity of a particular item in the cart). The shopping system 130 stores 414 a list of the cart items as the user browses the items in the shopping system 130 and changes the contents of the shopping cart.

If a user desires to share the shopping cart with another user of the shopping system 130, the user initiates a request to share a shopping cart on the client device 110. For example, the user selects a share button 206 displayed with the shopping cart, as shown in FIG. 2. When initiated, the client device 110 sends 416 the shopping system 130 a request for a URL corresponding to the shopping cart. In response, the shopping system 130 generates 418 a URL for the cart. The URL generated for a shopping cart uniquely references the items in the shopping cart at the time the URL was requested. In various embodiments, the shopping system 130 may assign the URL an expiration time and add an identifier of the user to the URL to attribute use of the URL to the user.

The shopping system 130 sends 320 the generated URL to the URL shortener 410, which generates 422 a shortened form of the URL. The URL shortener 410 associates the URL with a unique key, and generates a shortened URL including the key. The URL shortener 310 returns 424 the shortened URL to the shopping system 130, which in turn returns 426 it to the client device 110. A user may then use the client device 110 to share 428 the URL with one or more other users. For example, the client device 110 displays the shortened URL as selectable text, which the user can select, copy, and paste into an email, an instant message, a social media post, or any other communication format. Alternatively, the client device 110 automatically generates a message including the shortened URL and provides the message to the user to send to one or more other users.

### Sharing Shopping Cart URLs

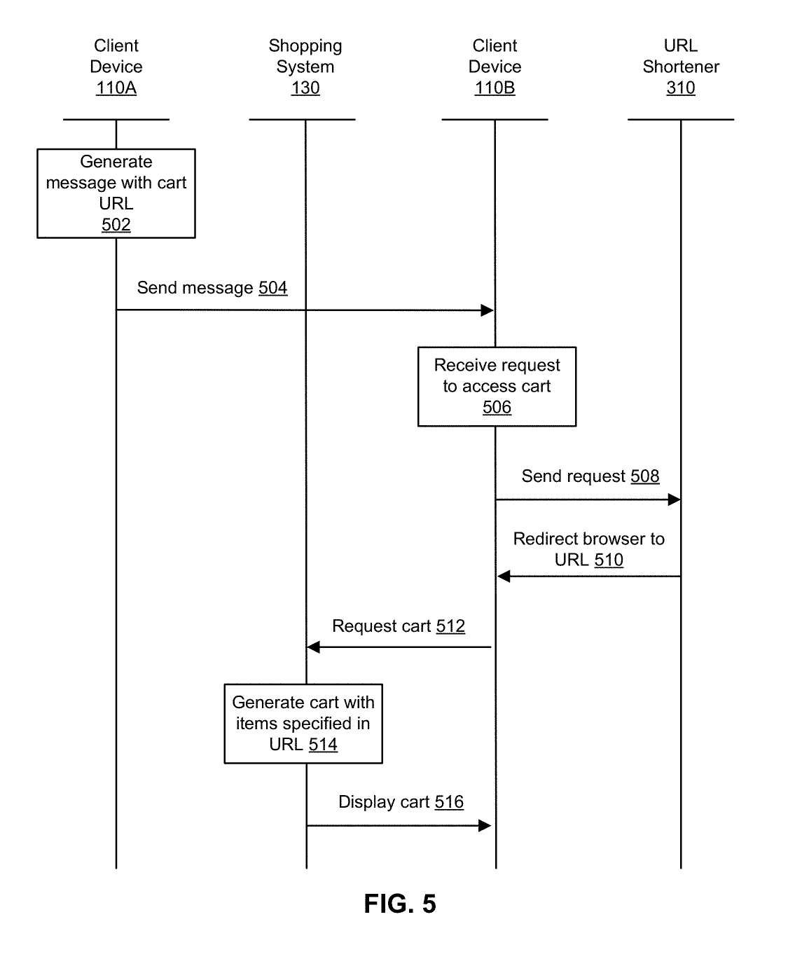

FIG. 5 is an interaction diagram illustrating one embodiment of a process for sharing a shopping cart URL. As shown in FIG. 5, the process may include interactions between two or more client devices 110, the shopping system 130, and the URL shortener 410. Other embodiments may include additional, fewer, or different steps, and may perform the steps in different orders. For example, as in FIG. 4, functions of the URL shortener 410 may be omitted or performed by the shopping system 130.

When a user desires to share a shopping cart with another user of the shopping system 130, the user uses a client device 110A to generate 502 a message including the URL. For example, the user uses the client device 110 to copy and paste a URL for the shopping cart into an email, an instant message, an SMS, or a social networking post, or the client device 110 automatically generates a message including the URL. The URL provided in the message may be a shortened URL that includes a key encoding a longer URL into fewer characters.

The client device 110A sends 504 the message to a client device 110B, used by a second user of the shopping system 130. Depending on the format of the message, sending 504 the message may comprise directing the message to a specific email address or phone number associated with the second user, sending a push notification to the client device 110B, posting the message to a social networking system for display by the client device 110B to any users of the social networking system or users of the social networking system connected to the first user, or sending the message by another means.

After the message has been sent 504 to the client device 110B, the client device 110B receives 506 a request to access the shopping cart. For example, a user of the client device 110B clicks on a link including the URL in the message, or copies the URL and pastes it into a web browser operating on the client device 110B. If the URL is shortened, the client device 110B sends 508 a request for the full URL to the URL shortener 410, which redirects 510 the web browser on the client device 110B to the full URL.

Using the full URL, the client device 110B requests 512 the shopping cart from the shopping system 130. In response to the request, the shopping system 130 generates 514 a shopping cart for the user of the client device 110B that includes the same items as the shopping cart generated by the user of the client device 110A, and sends the generated cart for display 516 by the client device 110B. For example, the shopping system 130 configures a page similar to the page 200 shown in FIG. 2 for display by the client device 110B. In one embodiment, when displaying 516 the shopping cart at the client device 110B, the shopping system 130 selects one or more advertisements to display to the user with the shopping cart. For example, the shopping system 130 selects advertisements for items similar to those in the shopping cart, or for gift items such as care packages, food, or gift cards that can be purchased with the items in the shopping cart.

The user of the client device 110B can purchase the items in the shopping cart configured for the user without independently searching for the items in the cart. The second user can also add or remove items from the shopping cart, or share the cart or a modified version of the cart with other users. Thus, the processes shown in FIGS. 4 and 5 may be repeated for any user who accesses a shopping cart through the shopping system 130.

### Example Applications

In one example application of the processes shown in FIGS. 4 and 5, the shopping system 130 is an educational system providing textbooks and other course materials for purchase by students. Near the start of each academic term, students are frequently required to purchase textbooks or other materials for the courses they are registered to take during the term. As a result, the number of users purchasing educational materials from the shopping system 130 may be significantly higher for a short period of time near the start of academic terms than during the rest of the year. Furthermore, many of the students may search for the same or similar set of books, since each student registered to a course is typically required to purchase the same books and multiple students are typically registered for each course. By enabling users to share shopping carts with others, such as the other students in their classes, the shopping cart URLs described herein may reduce the amount of time students spend searching for and purchasing textbooks and reduce server resources used to perform these searches during peak times. For example, if a student shares a cart with other students registered for the same course or courses, the other students can purchase their required textbooks without independently searching for the same books.

In another example, a user of the shopping system 130 sends the shopping cart to another individual to purchase the items in the cart for the user. For example, a student configures the shopping cart to include the textbooks and course materials the student is required to purchase for an academic term, and sends the cart to a family member to purchase the books. When the second user accesses the URL, the shopping system 130 configures a cart with the first user's selected items that the second user can then purchase without independently searching for the items. By sharing the URL, the first user ensures that the second user purchase the exact items the first user intended. The shopping system 130 may also allow the second user to purchase a cart without creating a user profile or logging into an account on the shopping system 130.

A user may alternatively share a shopping cart with a number of other users of the shopping system 130 through, for example, a social networking system. When other users access a shopping cart URL provided by the user, the shopping system 130 attributes credits to the user for each other user that accesses the URL. The shopping system 130 may offer incentives to users based on the number of credits they receive. For example, the shopping system 130 offers a discount to users who receive more than a threshold number of credits. As another example, the shopping system 130 ranks users based on the number of credits, and offers free or discounted items to users ranked above a threshold ranking.

In one embodiment, the shopping system 130 generates shopping carts automatically and distributes URLs referencing the automatic carts. One type of automatic shopping cart may be generated by analyzing user search patterns and purchase history to identify items that are frequently purchased together. For example, the shopping system 130 determines that users frequently purchase a particular solutions manual with a textbook because the probability that a user will purchase the solutions manual given the user's purchase of the textbook is greater than the probability that any arbitrary user of the shopping system 130 will purchase the solutions manual. As another example, the shopping system 130 determines that users frequently search for items A and B within a relatively short period of time (e.g., within the same shopping session) because the probability that a user will search the shopping system 130 for item B given that the user has searched for item A is greater than the probability that an arbitrary user of the system will search for item B. The shopping system 130 generates a shopping cart including identifiers of the items determined to be frequently purchased together or for which users frequently search together. Another type of shopping cart automatically generated by the shopping system 130 may contain different versions of items in a shopping cart created by a user. For example, the shopping system 130 generates a cart including newer editions of textbooks contained in a shopping cart previously created by a user, or including newer models of electronic products in a previously-created cart. The shopping system 130 may send a URL corresponding to an automatically-generated cart to, for example, any user who searches the shopping system 130 for one of the items in the cart.

Another type of automatic shopping cart that may be generated by the shopping system 130 is a shopping cart containing items a user has purchased previously. For example, if a user purchases one or more consumable goods from the shopping system 130 that the user is expected to use and replenish within an estimated period of time, the shopping system 130 generates a cart containing the goods and sends a URL corresponding to the cart to the user near the end of the estimated period of time. The user can then use the URL to access a pre-made cart containing the items the user needs to replenish, without needing to search the shopping system 130 for the items and manually add them to a shopping cart.

Accordingly, the shopping system 130 as described herein simplifies shopping for and purchasing items through an online system by enabling users to share shopping carts. Because users may purchase items through shared shopping carts rather than searching for items individually, the number of search queries executed by the shopping system 130 is reduced and users can more easily and quickly purchase desired items.

### Additional Configuration Considerations

The present invention has been described in particular detail with respect to several possible embodiments. Those of skill in the art will appreciate that the invention may be practiced in other embodiments. The particular naming of the components, capitalization of terms, the attributes, data structures, or any other programming or structural aspect is not mandatory or significant, and the mechanisms that implement the invention or its features may have different names, formats, or protocols. Further, the system may be implemented via a combination of hardware and software, as described, or entirely in hardware elements. Also, the particular division of functionality between the various system components described herein is merely exemplary, and not mandatory; functions performed by a single system component may instead be performed by multiple components, and functions performed by multiple components may instead performed by a single component.

Some portions of above description present the features of the present invention in terms of algorithms and symbolic representations of operations on information. These algorithmic descriptions and representations are the means used by those skilled in the data processing arts to most effectively convey the substance of their work to others skilled in the art. These operations, while described functionally or logically, are understood to be implemented by computer programs. Furthermore, it has also proven convenient at times to refer to these arrangements of operations as modules or by functional names, without loss of generality.

Unless specifically stated otherwise as apparent from the above discussion, it is appreciated that throughout the description, discussions utilizing terms such as “determining” or the like, refer to the action and processes of a computer system, or similar electronic computing device, that manipulates and transforms data represented as physical (electronic) quantities within the computer system memories or registers or other such information storage, transmission or display devices.

Certain aspects of the present invention include process steps and instructions described herein in the form of an algorithm. It should be noted that the process steps and instructions of the present invention could be embodied in software, firmware or hardware, and when embodied in software, could be downloaded to reside on and be operated from different platforms used by real time network operating systems.

The present invention also relates to an apparatus for performing the operations herein. This apparatus may be specially constructed for the required purposes, or it may comprise a general-purpose computer selectively activated or reconfigured by a computer program stored on a computer readable medium that can be accessed by the computer and run by a computer processor. Such a computer program may be stored in a computer readable storage medium, such as, but is not limited to, any type of disk including floppy disks, optical disks, CD ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

In addition, the present invention is not limited to any particular programming language. It is appreciated that a variety of programming languages may be used to implement the teachings of the present invention as described herein, and any references to specific languages, such as HTML or HTML5, are provided for enablement and best mode of the present invention.

The present invention is well suited to a wide variety of computer network systems over numerous topologies. Within this field, the configuration and management of large networks comprise storage devices and computers that are communicatively coupled to dissimilar computers and storage devices over a network, such as the Internet.

Finally, it should be noted that the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention.

What is claimed is:

1. A method for sharing digital shopping carts, the method comprising:
receiving, at an online shopping system, a digital shopping cart representing a set of identifiers of one or more items offered for sale by the shopping system and selected for purchase by a first user;
generating a uniform resource locator (URL) that uniquely references the digital shopping cart;
receiving a request from a second user to access the URL; and
responsive to receiving the request, configuring a digital shopping cart for the second user that includes the set of identifiers of the one or more items.

2. The method of claim 1, further comprising:
displaying to the first user, identifiers of a plurality of items offered for sale by the shopping system;
receiving selections by the first user of the one or more items associated with the digital shopping car; and
responsive to receiving the selections, adding the one or more items to the digital shopping cart.

3. The method of claim 1, wherein generating the URL comprises assigning a time of expiry to the URL, wherein the digital shopping cart is configured for the second user if the request from the second user is received prior to the time of expiry and not configured after the time of expiry.

4. The method of claim 1, wherein the URL encodes identifiers of the one or more items in the digital shopping cart and quantities of each of the one or more items.

5. The method of claim 1, further comprising:
receiving a request from the first user or the second user to purchase the items in the digital shopping cart; and
providing a payment portal to the first user or second user to purchase the items in the digital shopping cart.

6. The method of claim 1, further comprising:
receiving a request from the second user to modify the configured shopping cart; and
generating a second URL uniquely referencing the modified shopping cart, wherein the online shopping system configures the modified shopping cart for a user responsive to the user accessing the second URL.

7. The method of claim 1, further comprising:
receiving a request from the first user to share the digital shopping cart;
wherein the URL is generated responsive to the request to share the digital shopping cart.

8. The method of claim 1, further comprising:
identifying one or more users connected to the first user via a social networking system; and
sending the URL to the identified users;
wherein the second user is one of the identified users.

9. The method of claim 1, wherein generating the URL comprises attributing the URL to the first user, and wherein an incentive is provided to the first user responsive to the request from the second user to access the URL.

10. A non-transitory computer-readable storage medium storing computer program instructions for sharing digital shopping carts, the computer program instructions when executed by a processor causing the processor to:
receive, at an online shopping system, a digital shopping cart representing a set of identifiers of one or more items offered for sale by the shopping system and selected for purchase by a first user;
generate a uniform resource locator (URL) that uniquely references the digital shopping cart;
receive a request from a second user to access the URL; and
responsive to receiving the request, configure a digital shopping cart for the second user that includes the set of identifiers of the one or more items.

11. The non-transitory computer-readable storage medium of claim 10, the computer program instructions when executed by the processor further causing the processor to:
display to the first user, identifiers of a plurality of items offered for sale by the shopping system;
receive selections by the first user of the one or more items associated with the digital shopping car; and
responsive to receiving the selections, add the one or more items to the digital shopping cart.

12. The non-transitory computer-readable storage medium of claim 10, wherein generating the URL comprises assigning a time of expiry to the URL, and wherein the digital shopping cart is configured for the second user if the request from the second user is received prior to the time of expiry and not configured after the time of expiry.

13. The non-transitory computer-readable storage medium of claim 10, wherein the URL encodes identifiers of the one or more items in the digital shopping cart and quantities of each of the one or more items.

14. The non-transitory computer-readable storage medium of claim 10, the computer program instructions when executed by the processor further causing the processor to:
receive a request from the first user or the second user to purchase the items in the digital shopping cart; and
provide a payment portal to the first user or second user to purchase the items in the digital shopping cart.

15. The non-transitory computer-readable storage medium of claim 10, the computer program instructions when executed by the processor further causing the processor to:
receive a request from the second user to modify the configured shopping cart; and
generate a second URL uniquely referencing the modified shopping cart, wherein the online shopping system configures the modified shopping cart for a user responsive to the user accessing the second URL.

16. The non-transitory computer-readable storage medium of claim 10, the computer program instructions when executed by the processor further causing the processor to:
receive a request from the first user to share the digital shopping cart;
wherein the URL is generated responsive to the request to share the digital shopping cart.

17. The non-transitory computer-readable storage medium of claim 10, wherein generating the URL comprises attributing the URL to the first user, and wherein an incentive is provided to the first user responsive to the request from the second user to access the URL.

18. A method for sharing digital shopping carts, the method comprising:
receiving, at an online shopping system, a digital shopping cart representing a set of identifiers of one or more items offered for sale by the shopping system and selected by the shopping system for purchase by one or more users;
generating a uniform resource locator (URL) that uniquely references the digital shopping cart;
providing the URL to the one or more users of the online shopping system;
receiving a request from a user to access the URL; and
responsive to receiving the request, configuring a digital shopping cart for the user that includes the set of identifiers of the one or more items.

19. The method of claim 18, further comprising:
receiving search queries from a plurality of users for items offered for sale by the online shopping system; and
generating the digital shopping cart based on the search queries.

20. The method of claim 18, further comprising:
identifying one or more items frequently purchased together by users of the online shopping system; and
generating the digital shopping cart based on the items frequently purchased together.
